(19) United States
(12) Patent Application Publication
(10) Pub. No.: US 2006/0028002 A1
(43) Pub. Date: Feb. 9, 2006

(54) Horn switch gear, airbag system, and steering wheel

(75) Inventors: Kei Tsujimoto, Hikone-shi (JP); Wataru Nakazawa, Higashiomi-shi (JP); Yoshitaka Matsui, Kanzaki-gun (JP); Masahiko Kaifuki, Aki-gun (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/193,530

(22) Filed: Aug. 1, 2005

(30) Foreign Application Priority Data
Aug. 5, 2004 (JP) 2004-229729
Dec. 10, 2004 (JP) 2004-358575
Jan. 19, 2005 (JP) 2005-011776
May 19, 2005 (JP) 2005-146871

(51) Int. Cl. B60R 21/16

(52) U.S. Cl. 280/731

(57) ABSTRACT

A horn switch gear includes a proximity sensor that is mounted on a first surface and a magnet that is mounted on a second surface, at a position facing the first surface. When a module cover is depressed, the first surface moves downward together with the module cover, thereby bringing the sensor close to the magnet. When the distance between the sensor and the magnet becomes less than a specified value, a voltage greater than a threshold is generated. In response to this above-threshold voltage, the sensor generates a horn blowing signal that sounds the horn. Another horn switch gear has a structure in which a horn is activated by depression of the module cover, which depression generates an induced current by the relative movement of a magnet and a magnetic coil.

### BACKGROUND

The present invention relates to a horn switch, and in particular, it relates to a horn switch gear provided in an airbag system and constructed such that, when depressed, the module cover or the entire airbag system is moved backward to activate the horn switch. The invention also relates to an airbag system including the horn switch gear and to a construction technique for a horn switch gear mounted to a vehicle steering wheel.

Driver-seat airbag systems mounted to car steering wheels are disclosed, e.g., Japanese Unexamined Patent Application Publication Nos. 10-100832 and 2001-114057. When the module, which covers of the airbag systems, is depressed, a horn switch is activated to blow a horn. Specifically, when the airbag cover of airbag system is depressed, a moving contact is physically brought into contact with a fixed contact, thereby activating the horn mechanism, which causes the horn to sound (also referred to as “blow”), i.e., the module cover is moved backward to activate the horn switch. In these conventional horn switch gears, one of contacts, e.g., a contact rivet, is mounted to the module cover whereas the other contact is mounted to the retainer. Unfortunately, as the contacts are disposed separately, it is difficult to position them with high accuracy. In addition, there is a keen demand for a technique to improve horn operability by minimizing the depression load necessary (and the associated operation stroke) to blow the horn.

Accordingly, the present invention has been made in light of the aforementioned problems. An object of the present invention is to facilitate the assembly of an airbag system (and a steering wheel that includes the airbag system) by providing a horn switch gear that uses no contacts to sound the horn. Another object of the present invention is to improve horn operability in a horn switch gear mounted on a steering wheel for vehicles.

### SUMMARY

To achieve the aforementioned objects, the present invention provides a novel construction technique for a horn switch gear mounted on a steering wheel for vehicles such as automobiles.

An embodiment of the invention addresses a horn switch gear that includes, among other possible things: (a) a backward moving body that is configured to move backward in a depression direction when depressed by an occupant; (b) an unmoving body that faces the backward moving body; (c) a biasing member that is interposed between the backward moving body and the unmoving body and that is configured to bias the backward moving body in a restoring direction that is opposite the depression direction; and (d) a signal generator that is configured to generate a horn blowing signal in response to the movement of the backward moving body in the depression direction. The signal generator includes a noncontact sensor.

In a further embodiment of this horn switch gear, the noncontact sensor may include a Hall IC.

Another embodiment of the present invention addresses an airbag system that includes, among other possible things: (a) a horn switch gear that includes, among other possible things: (i) a backward moving body that is configured to move backward in a depression direction when depressed by an occupant; (ii) an unmoving body that faces the backward moving body; (iii) a biasing member that is interposed between the backward moving body and the unmoving body and that is configured to bias the backward moving body in a restoring direction that is opposite the depression direction; and (iv) a signal generator that is configured to generate a horn blowing signal in response to the movement of the backward moving body in the depression direction. The signal generator includes a noncontact sensor.

In a further embodiment of this airbag system, the noncontact sensor may include a Hall IC.

Another embodiment of the present invention addresses a steering wheel that includes, among other possible things: (a) a horn switch gear that includes, among other possible things: (i) a backward moving body that is configured to move backward in a depression direction when depressed by an occupant; (ii) an unmoving body that faces the backward moving body; (iii) a biasing member that is interposed between the backward moving body and the unmoving body and that is configured to bias the backward moving body in a restoring direction that is opposite the depression direction; and (iv) a signal generator that is configured to generate a horn blowing signal in response to the movement of the backward moving body in the depression direction. The signal generator includes a noncontact sensor.

In a further embodiment of this steering wheel, the noncontact sensor may include a Hall IC.

In another further embodiment of this steering wheel, the steering wheel may also include an airbag system that, in turn, includes the horn switch gear.

In the conventional horn switch gear, which uses a contact rivet, the horn does not blow until the contact rivets come into contact, thereby closing the circuit. In other words, the contact rivets must come into contact with each other when the module cover is pushed.

In contrast, with the aforementioned horn switch gear, the airbag system, and the steering wheel, the horn blowing signal is generated by a noncontact sensor. Accordingly, the sensor-activating member (e.g., a magnet) for causing the noncontact sensor (e.g., a Hall IC) to output the signal is operational provided it comes within a specified distance from the noncontact sensor, when the backward moving body is pushed backward, i.e., contact is not required. As the sensor activating member only has to be brought within a specified distance of the noncontact sensor, the required assembly accuracy of the horn switch gear (and the airbag system incorporating the horn switch gear) is reduced. Moreover, as the horn switch gear employs a noncontact system, it has high durability and does not affect the operating characteristics even if slight water enters the vicinity of the horn switch.

Another embodiment of the present invention a horn switch gear provided on a vehicle steering wheel, the horn switch gear includes, among other possible things: (a) a first component; (b) a second component that is biased a specified distance away from the first component by a biasing element that generates a biasing force; (c) a magnet; and (d) a magnetic coil. The second component is configured to be moved by being depressed, against the biasing force, to an operating position at which a horn is configured to sound. The movement of the second component toward the operating position is in a direction toward the first component. The sounding of the horn is configured to be terminated by releasing the depression on the second member. The magnet moves relative to the magnetic coil when the second component moves toward the operating position. The movement of the magnet relative to the magnetic coil induces current in the magnetic coil, thereby sounding the horn.

Here the term “first component” typically includes the steering wheel itself and members provided on the steering wheel side. The term “second component” typically includes a module cover (module pad) that covers the airbag of the steering wheel from the occupant side, a horn operating cover that is used only to activate the horn, and a horn operating button (switch).

The magnet and the magnetic coil have a structure in which they move relatively in the direction in which they come close to each other or in the direction in which they separate from each other when the second component moves toward the operating position while moving relative to the first component. The structure includes a structure in which a moving-side magnetic coil moves relative to a fixed-side magnet, a structure in which a moving-side magnet moves relative to a fixed-side magnetic coil, and a structure in which both of the magnet and the magnetic coil move. When the second component moves toward the operating position, the magnet and the magnetic coil move relatively to generate an induced current in the magnetic coil, thereby operating the horn by the generation of the induced current. Typically, the horn is activated when the horn switch senses the induced current generated in the magnetic coil by the relative movement of the magnet and the magnetic coil. This structure uses a so-called “principle of electromagnetic induction.” Any or all of the following can be set so that the magnetic coils can pass a current higher than a specified induced current at the depression of the second component: (a) the magnetic force (magnetic flux density) of the magnet; (b) the diameter of the magnetic coil; (c) the number of windings of the magnetic coil; (d) the pressure required for the occupant to depress second component to the operating position (i.e., the elastic biasing force of the coil springs to elastically bias the second component to the initial position); and (e) the operation stroke of the module cover 116.

The use of the horn switch gear according to this embodiment allows a current higher than a specific induced current to flow in the magnetic coil, while reducing the pressure and operation stroke required to depress the second component by adjusting the magnetic force (magnetic flux density) of the magnet, and the diameter and the number of windings of the magnetic coil. Also, the operability of the horn switch gear can be improved by reducing the pressure and operation stroke required to depress the second component. The reduction of the operation stroke of the second component can minimize a gap (or clearance) formed between the moving-side second component and the fixed-side component disposed close to the second component, thereby enhancing the overall appearance of a steering device that incorporates such a horn switch gear.

The horn switch gear according to this embodiment only has to have a structure in which the magnet and the magnetic coil move relatively with the depression of the second component; the mounting positions of the magnet and the magnetic coil are not limited. The structure includes a structure in which the first component has a magnet and the second component has a magnetic coil, a structure in which the first component has a magnetic coil and the second component has a magnet, and a structure in which the first component or the second component has both a magnet and a magnetic coil.

In the horn switch gear according to this embodiment, the relative movement of the magnet and the magnetic coil may use the relative movement of the first component and the second component directly or indirectly. An example of the direct use of the relative movement of the first component and the second component includes a structure in which the first component has a magnetic coil, the second component has a magnet, and the magnet moves directly relative to the magnetic coil as with the movement of the second component relative to the first component. On the other hand, an example of the indirect use of the relative movement of the first component and the second component includes a structure in which a member that is operatively connected to the first component has a magnetic coil, a member that is operatively connected to the second component has a magnet, and the magnet moves indirectly relative to the magnetic coil with the movement of the second component relative to the first component.

The horn switch gear according to this embodiment only has to have a structure in which the horn is activated using the induced current generated by the relative movement of the magnet and the magnetic coil. For example, the induced current may be used as the direct power supply for the horn switch to activate the horn or, alternatively, as the power supply for the controller that controls the operation of the horn switch.

In a further embodiment of this horn switch gear, one of the first and second components may include the magnet, and the other of the first and second components may include the magnetic coil. Accordingly, the magnet and the magnetic coil move relatively as the second component and the first component move relatively when the second component is depressed. This structure includes a structure in which the first component has a magnet and the second component has a magnetic coil, and a structure in which the first component has a magnetic coil and the second component has a magnet. Accordingly, as the horn switch gear according to this further embodiment has a structure in which the relative movement of the magnet and the magnetic coil uses the relative movement of the first component and the second component, the structure is simplified.

In another further embodiment of this horn switch gear, the magnetic coil may be a coil spring interposed between the first and second components. Moreover, the coil spring may be configured to elastically bias the second component the specified distance away from the first component. According to this further embodiment, the coil spring may serve as magnetic coil that generates an induced current when the second component is pushed from the initial position to the operating position against the elastic biasing force of the coil spring. Accordingly, the use of the horn switch gear according to this further embodiment may improve the horn operability and may enhance the overall appearance of a steering device that includes such a horn switch gear. Also, the common use of the magnetic coil and the coil spring reduces the number of components, thereby reducing the number of parts for, and facilitating the assembly of, the horn switch gear.

Another embodiment of the present invention addresses an airbag system that includes, among other possible things: (a) a vehicle steering wheel; (b) a horn switch gear provided on the vehicle steering wheel, the horn switch gear including, among other possible things: (i) a first component; (ii) a second component that is biased a specified distance away from the first component by a biasing element that generates a biasing force; (iii) a magnet; and (iv) a magnetic coil, wherein the second component is configured to be moved by being depressed, against the biasing force, to an operating position at which a horn is configured to sound, wherein the movement of the second component toward the operating position is in a direction toward the first component, wherein the sounding of the horn is configured to be terminated by releasing the depression on the second member, wherein the magnet moves relative to the magnetic coil when the second component moves toward the operating position, and wherein the movement of the magnet relative to the magnetic coil induces current in the magnetic coil, thereby sounding the horn; (c) an airbag that is configured to be deployed toward an occupant in the event of a collision; (d) a retainer that accommodates the airbag in a folded state; (e) an inflator that is configured to supply inflation gas to the airbag; and (f) an airbag cover that covers a part of the airbag that is adjacent to the occupant. In a collision, the airbag cover may be cleaved by a deploying force of the vehicle airbag, thereby allowing the vehicle airbag to deploy in the occupant protection region.

In a further embodiment of this airbag system, one of the first and second components may include the magnet and the other of the first and second components may include the magnetic coil.

In another further embodiment of this airbag system, the magnetic coil may be a coil spring interposed between the first and second components. Further, the coil spring may be configured to elastically bias the second component the specified distance away from the first component.

In another further embodiment of this airbag system, the horn switch gear may be part of a horn operating member that additionally includes a pad member and a button.

In this airbag system, the horn operability and the appearance of the airbag system may be improved.

In other embodiment of this airbag system, the second component of the horn switch gear may be provided only to operate the horn independently from the airbag cover or, alternatively, it may be used also as the airbag cover. When the second component of the horn switch gear is used also as the airbag cover, the horn switch gear may operate together with the retainer side member by depression or, alternatively, may operate in isolation from the retainer side member. In other words, the horn switch gear may be of a so-called floating cover (floating pad) type in which the horn operating member floats on the retainer.

Another embodiment of the present invention address a steering device that includes, among other possible things: (a) a vehicle steering wheel; (b) a horn switch gear provided on the vehicle steering wheel, the horn switch gear including, among other possible things: (i) a first component; (ii) a second component that is biased a specified distance away from the first component by a biasing element that generates a biasing force; (iii) a magnet; and (iv) a magnetic coil, wherein the second component is configured to be moved by being depressed, against the biasing force, to an operating position at which a horn is configured to sound, wherein the movement of the second component toward the operating position is in a direction toward the first component, wherein the sounding of the horn is configured to be terminated by releasing the depression on the second member, wherein the magnet moves relative to the magnetic coil when the second component moves toward the operating position, and wherein the movement of the magnet relative to the magnetic coil induces current in the magnetic coil, thereby sounding the horn; (c) an airbag that is configured to be deployed toward an occupant in the event of a collision; (d) a retainer that accommodates the airbag in a folded state; (e) an inflator that is configured to supply inflation gas to the airbag; and (f) an airbag cover that covers a part of the airbag that is adjacent to the occupant.

In a further embodiment of this steering device, one of the first and second components may include the magnet and the other of the first and second components may include the magnetic coil.

In another further embodiment of this steering device, the magnetic coil may be a coil spring interposed between the first and second components. Further, the coil spring may be configured to elastically bias the second component the specified distance away from the first component.

In this steering device, the horn operability and the appearance of the steering device may be improved.

As the horn switch gear for vehicles according to the invention may have a structure in which the magnet and the magnetic coil are moved relatively by the depression of the second component by the occupant such that the horn is activated by the induced current generated by the relative movement, the horn operability may be improved.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a cross-sectional view of a steering wheel with an airbag system including a horn switch gear according to an embodiment of the present invention;

FIG. 2 is a cross-sectional view of the horn switch gear in FIG. 1;

FIG. 3 is a cross-sectional view of a horn switch gear according to another embodiment of the present invention;

FIG. 4 is a cross-sectional view of a steering wheel with an airbag system including a horn switch gear according to still another embodiment of the present invention;

FIG. 5 is a cross-sectional view of a steering device according to another embodiment of the present invention;

FIG. 6 is a schematic diagram showing the operation of a magnet and a magnetic coil used in the horn switch gear of the embodiment shown in FIG. 5;

FIG. 7 is a cross-sectional view of a steering device according to another embodiment of the present invention;

FIG. 8 is a cross-sectional view of a steering device according to another embodiment of the present invention; and

FIG. 9 is a cross-sectional view of a steering device according to another embodiment of the present invention.

### DETAILED DESCRIPTION

Embodiments of the present invention will be described with reference to the drawings. Like numbers are used throughout the drawings to refer to the same or similar parts in each of the embodiments of the invention described herein.

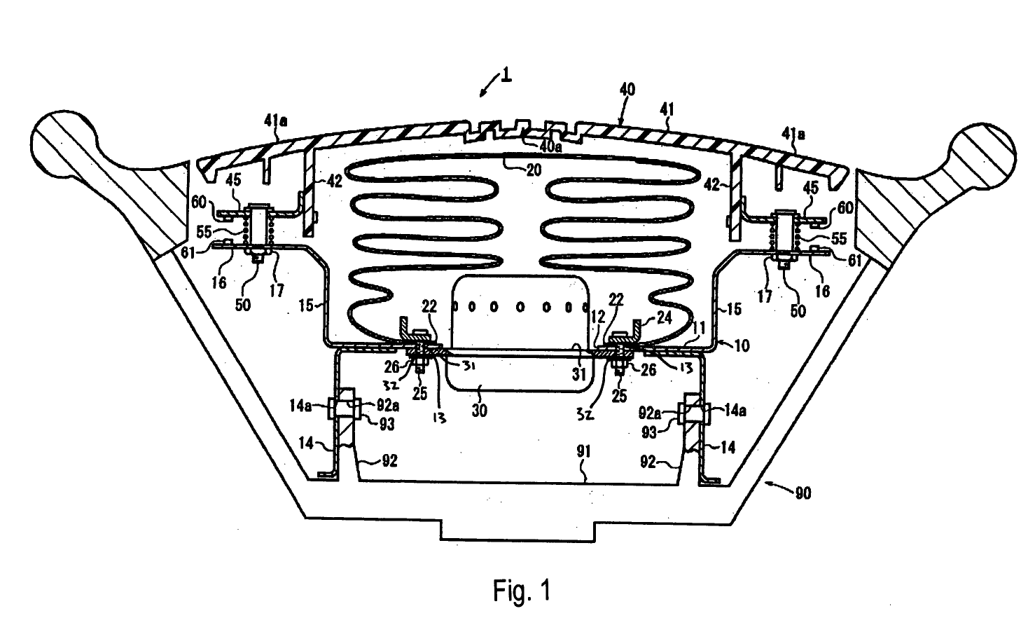

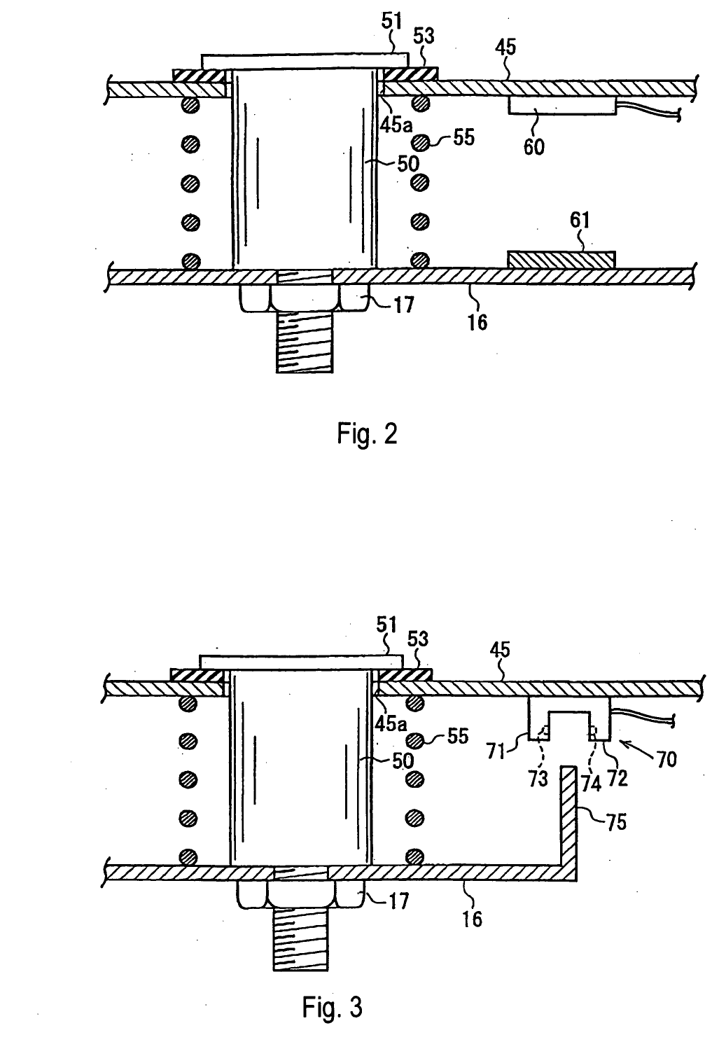

FIG. 1 is a cross-sectional view of a steering wheel 90 with an airbag system 1 that includes a horn switch gear according to an embodiment of the present invention. FIG. 2 is an enlarged view of the horn switch gear in FIG. 1.

The airbag system 1 is a driver-seat airbag system disposed in the center (base 91) of a steering wheel 90. The airbag system 1 includes a metal retainer 10, an airbag 20 mounted to the retainer 10 with an airbag-fixing ring 24, an inflator 30 for inflating the airbag 20, a synthetic resin module cover 40 that covers the folded airbag 20, and a horn switch gear having a proximity sensor 60. The retainer 10 may be made of, e.g., resin, magnesium alloys, etc.

The module cover 40 has a groove-like tear line 40a. When the airbag 20 is inflated by the inflator 30, the module cover 40 is cleaved along the tear line 40a.

The retainer 10 has a substantially rectangular main plate 11. The main plate 11 has an opening 12 for the inflator 30 to pass through. Around the opening 12 are provided through holes for stud bolts 25 extending from the airbag-fixing ring 24.

An anchor piece 14 stands downward in the drawing (in the direction opposite to the occupant) from the outer rim of the main plate 11 of the retainer 10. The anchor piece 14 is used to fix the airbag system 1 to the steering wheel 90. The anchor piece 14 has openings 14a for connectors, e.g., bolts, to pass therethrough. An airbag mounting piece 92 stands so as to extend from the base 91 of the steering wheel 90. The mounting piece 92 also has openings 92a for bolts, rivets, etc. to pass therethrough.

In mounting the airbag system 1 to the steering wheel 90, the anchor piece 14 is superposed on the mounting piece 92, and then the bolts or rivets 93, etc. are passed through the openings 14a, 92a to connect the anchor piece 14 and the mounting piece 92. The openings 14a, 92a may be, e.g., bolt screw holes.

An enclosure 15 stands upward in FIG. 1 (toward the occupant) from the outer rim of the main plate 11 of the retainer 10. Extension 16 extends laterally (to the side of the airbag system 1) from the end of the enclosure 15 in the standing direction. Nuts 17 engage guide shafts 50 that are journalled through the extensions 16.

The airbag 20 has a structure in which the periphery of an inflator insertion hole 22 thereof is placed on the periphery of the inflator opening 12 of the retainer main plate 11, on which the airbag-fixing ring 24 is placed. The stud bolts 25 are passed through the bolt insertion holes provided around the inflator insertion hole 22. Each stud bolt 25 is then passed through a bolt insertion hole 13 of the retainer 10. The stud bolt 25 is then passed through a bolt insertion hole 32 of a flange 31 of the inflator 30, on which a nut 26 is tightened. The airbag 20 and the inflator 30 are thus fixed to the retainer 10.

The module cover 40 has a main surface 41 that faces the occupant and a leg 42 extending from the back of the main surface 41. The leg 42 is molded integrally with the main surface 41 by, e.g., injection molding of synthetic resin and has a substantially rectangular frame shape as with the enclosure 15 of the retainer 10. The periphery 41a of the main surface 41 overhangs outward from the leg 42.

Overhangs 45 are fixed to the legs 42 with fixing members, e.g., rivets (not shown). The overhangs 45 extend (horizontally in FIGS. 1 and 2) outward to the side orthogonal to the forward and backward moving direction (vertically in FIGS. 1 and 2) of the module cover 40. The overhangs 45 have openings 45a (FIG. 2) at the end in the extending direction, through which the guide shafts 50 are passed.

As shown in FIG. 2, the lower end of each guide shaft 50 is screwed into the nut 17 of the associated extension 16, thereby fixing the guide shafts 50 to the extensions 16. The guide shafts 50 extend from the extensions 16 toward the occupant. Flanges 51 are provided as stoppers at the upper rims of the guide shafts 50. Cushioning washers 53, which may be of rubber or the like, are interposed between the flanges 51 and the overhangs 45.

A coil spring 55 is provided around each of the guide shafts 50. The coil springs 55 serve to bias the ends of the overhangs 45 away from the associated extensions 16.

Magnetosensitive proximity sensors 60, which may include, e.g., a Hall IC (i.e., an integrated circuit in which a Hall element serving as magnetosensitive element is assembled in the circuit), are mounted to the lower surfaces of the overhangs 45. Magnets 61 are mounted to upper surfaces of the extensions 16 such that the magnets 61 face the proximity sensors 30 depending from the corresponding overhangs 45. Each pair of associated proximity sensors 60 and magnets 61 constructs a horn switch. Each of the horn switches may be electrically connected to one master horn switch (not shown) that may control the sounding of the horn (e.g., a Klaxon horn), when any one or more of the sensor 60 and magnet 61 pairs is activated.

The horn blowing operation of the airbag system with this horn switch will be described.

When the module cover 40 is not depressed, the coil springs 55 pushes their associated overhangs 45 to the corresponding flanges 51. In this state, the proximity sensors 60 are sufficiently apart from the magnets 61, thereby preventing a voltage from being generated (in the Hall ICs).

In contrast, when the module cover 40 is depressed, the overhangs 45 are moved downward together with the module cover 40, thereby moving the sensors 60 close to the magnets 61. As the extensions 16 are integral with the retainer 10 and as the retainer 10 is fixed to a steering wheel (not shown), when the module cover 40 is depressed, the extensions 16 do not move backward. As a result, when the distance between the sensors 60 and the associated magnets 61 becomes less than a specified distance, the proximity sensors 60 (i.e., the Hall ICs therein) generate a voltage that is greater than a threshold, owing to the magnetic flux from the magnets 61. As a result of the above-threshold voltage, the sensors 60 generate a horn blowing signal. In response to the signal, a horn operating circuit (not shown) sounds the horn. The horn operating circuit may either be assembled in the proximity sensor 60 or be provided separately.

When the module cover 40 is released, the overhangs 45 are pushed up into contact with the flanges 51 by the pressure of the coil springs 55, thereby returning the module cover 40 to the normal position shown in FIG. 1. When the overhangs 45 move upward, the intensity of the magnetic field of the magnets 61 to the proximity sensors 60 is reduced to a level less than the specified threshold value. As a result, the sensors 60 terminate the horn blowing signal, thereby stopping the blowing of the horn.

According to the aforementioned embodiment, the distance between the proximity sensor 60 and the magnet 61 is uniquely defined by the length of the guide shaft 50. Accordingly, even if the accuracy of the lateral position of the sensors 60 and the magnets 61 is not high, the horn is still configured to blow reliably when the module cover 40 is depressed by more than the specified distance. As a result, the accuracy required to position of the sensors 60 on the overhangs 45 and the magnets 61 on the extensions 16 is reduced, thereby improving the efficiency of the assembling the airbag system.

As the sensors 60 are of a noncontact type, the sensors 60 have high durability. Moreover, even if water enters between the sensors 60 and the associated magnets 61, the horn switch operation is unaffected.

As previously discussed, in this embodiment the overhangs 45 are disposed above the extensions 16 such that the overhangs 45 and the extensions 16 approach each other when the module cover 40 is depressed. Alternatively, the overhangs 45 may be disposed below the extensions 16 so that they come apart from each other when the module cover 40 is depressed; in this case, when the module cover 40 is depressed to some extent, the output signal from the sensor 60 may be stopped and the stoppage of the output signal may cause the horn to sound.

FIG. 3 is a cross-sectional view of an airbag system including a horn switch according to another embodiment, showing some of the same parts as that of FIG. 2. All other parts of this embodiment may be similar to that shown in FIG. 1 and, therefore, the same reference numerals indicate the same components.

The embodiment of FIG. 3 uses optical sensors as a proximity sensors 70. Each of the sensors 70 includes a pair of opposing wall-like bases 71 and 72 depending from the associated overhang 45, a light-emitting element 73 disposed on an inner face of one of the wall-like bases 71, and a light-receiving element 74 disposed on the inner wall of the opposing wall-like base 72. The extensions 16 have upstanding walls 75 that are configured to enter the space between the wall-like bases 71 and 72, when the module cover 40 is depressed. The light-emitting element 73 of each of the sensors 70 continuously emits light while the key of the car is in ON-position; the emitted light is received by the associated light-receiving element 74. A light-reception signal (H) generated by light-receiving element 74 is inputted to a horn operating circuit (not shown) such that the horn is not sounded. In contrast, when the module cover 40 is depressed, thereby forcing the upstanding walls 75 into the spaces between the wall-like bases 71, 72, the light emitted by the light-emitting elements 73 is prevented from reaching the light-receiving elements 74. As a result, a light-interception signal (L) is generated by the light-receiving elements 74, thereby instructing the horn to blow.

Each of the horn switches may be electrically connected to one master horn switch (not shown) that may control the sounding of the horn, when any one or more of the light-emitting element 73 and light-receiving element 74 pair is activated.

Also in this embodiment, the distance between the overhang 45 and the extension 16 is uniquely defined by the guide shaft 50 to easily keep the height of the upstanding wall 75 constant with high accuracy. The sensors 70 only have to be fixed to the overhangs 45 so that the upstanding walls 75 enter between the wall-like bases 71 and 72, when the module cover 40 is depressed. As a result, the positioning accuracy of the sensors 70 on the overhangs 45 can be low, thereby improving the efficiency of the assembling an airbag system.

As the sensors 70 are of a noncontact type, the sensors 70 have high durability. Moreover, the wall-like bases 71, 72 and the upstanding walls 75 inhibit the likelihood that water will interfere with sensors 70 such that the horn switch operation is largely unaffected.

As previously discussed, in this embodiment the overhangs 45 are disposed above the extensions 16 such that the overhangs 45 and the extensions 16 approach each other when the module cover 40 is depressed. Alternatively, the overhangs 45 may be disposed below the extensions 16 so that they come apart from each other when the module cover 40 is depressed, i.e., the upstanding walls 75 are moved away from being between the elements 73 and 74 such that when light is received by the light-receiving elements 74, the light-receiving elements may generate a signal to blow the horn.

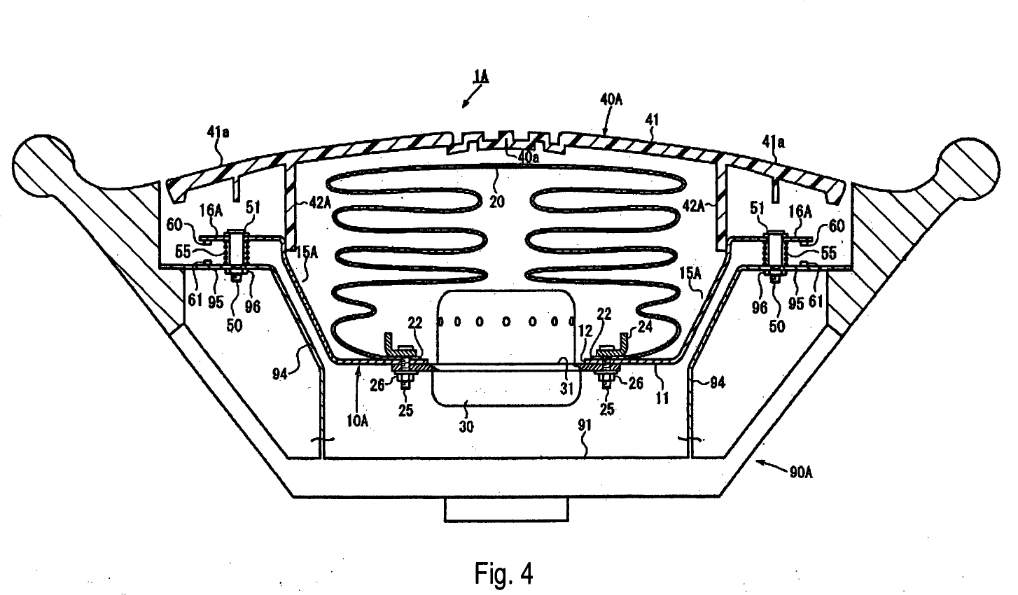

The above embodiments are constructed such that the module cover 40 moves backward to turn on the horn switch. Alternatively, the entire airbag system may be moved backward to turn on the horn switch. FIG. 4 is a cross-sectional view of a steering wheel with an airbag system with such a structure. The other structures of the airbag system 1A and the horn switch are the same as those of the embodiment of FIGS. 1 and 2 and, therefore, the numerals of FIG. 4 that are the same as those of FIGS. 1 and 2 indicate the same components.

The airbag system 1A also includes a retainer 10A, an airbag 20 mounted to the retainer 10A with an airbag-fixing ring 24, an inflator 30 for inflating the airbag 20, a module cover 40A that covers the folded airbag 20, and horn switch gears having the proximity sensors 60.

The retainer 10A of this embodiment, like that of the retainer 10 of the embodiments shown in FIGS. 1-3, has a substantially rectangular main plate 11 to which the airbag 20 and the inflator 30 are mounted. Moreover, the mounting structure is the same as that of the airbag systems 1 of FIGS. 1-3.

An enclosure 15A stands upward in FIG. 4 (i.e., toward the occupant) from the outer rim of the main plate 11 of the retainer 10A. Extensions 16A extend laterally (i.e., to the side of the airbag system 1A and in the direction orthogonal to the forward and backward moving direction of the airbag system 1A) from the end of the enclosure 15A.

The module cover 40A has a main surface 41 that faces the occupant and a leg 42A that extends from the back of the main surface 41 downward in FIG. 4 (in the opposite direction to the occupant) along the inside wall of the enclosure 15A. The leg 42A is fixed to the enclosure 15A with a fixing member such as a rivet (not shown).

In this embodiment, airbag-system supporting pieces 94 stand from a base 91 of a steering wheel 90A along the outside wall of the enclosure 15A. The number of supporting pieces 94 corresponds to the number of the extensions 16A. Moreover, the supporting pieces 94 are disposed such that their respective ends face corresponding extensions 16A from below. At the end of each supporting piece 94, there is provided a facing part 95 that extends to the side of the airbag system 1A (i.e., parallel to the direction in which the corresponding extension 16A extends) and that faces the lower surface of the extension 16A. In this embodiment, nuts 96 for fixing each of the guide-shaft 50 are provided on the facing parts 95.

In this embodiment, each extension 16A has an opening (its reference numeral is omitted), through which the guide shaft 50 is passed. The lower end of a guide shaft 50 is fixed to the corresponding facing part by means of the nut 96; the guide shaft 50 stands upward from the facing part 95. Also in this embodiment, the flange 51 is provided as stopper (not shown) at the upper rim of the guide shaft 50. Between the flange 51 and the extension 16A is interposed a cushioning washer (its reference numeral is omitted) made of rubber or the like.

A coil spring 55 is provided around each of the guide shafts 50. The coil springs 55 serve to bias the ends of the facing parts 95 away from the associated extensions 16A.

The entire airbag system 1A is supported by the supporting pieces 94 (steering wheel 90A) so as to move forward and backward along the guide shafts 50 via the guide shaft 50 and the coil springs 55.

In this embodiment, magnetosensitive proximity sensors 60 (possibly having a Hall IC) are mounted to the lower surface of the extensions 16A and magnets 61 are mounted on the upper surface of the facing parts 95. Conversely, the proximity sensors 60 may be mounted on the upper surface of the facing parts 95 and the magnets 61 may be mounted on the lower surface of the extension 16A. Briefly, like the embodiments of FIGS. 1-3, the proximity sensors 60 and the magnets 61 construct a horn switch. The other structures of the airbag system 1A and the horn switch are the same as those of the embodiment of FIGS. 1 and 2 and, therefore, the numerals of FIG. 4 that are the same as those of FIGS. 1 and 2 indicate the same components.

The horn blowing operation of the airbag system 1A with this horn switch will now be described.

When the module cover 40A is not depressed, the coil springs 55 push the extensions 16A to their corresponding flanges 51. In this state, the proximity sensors 60 are sufficiently apart from the magnets 61, thereby preventing a voltage from being generated (in the Hall ICs).

When the module cover 40A is depressed, the entire airbag system 1A is moved downward along the guide shafts 50, thereby moving the extensions 16A toward the facing parts 95 to bring the sensors 60 close to the magnets 61. As the facing parts 95 (supporting pieces 94) are integral with the steering wheel 90A, when the module cover 40A is depressed, the facing parts 95 do not moved backward. As a result, when the distance between the sensors 60 and the associated magnets 61 becomes less than a specified distance, the proximity sensors 60 (i.e., the Hall ICs) generate a voltage that is greater than a threshold, owing to the magnetic flux from the magnets 61. As a result of the above-threshold voltage, the sensors 60 generate a horn blowing signal. In response to the signal, a horn operating circuit (not shown) sounds the horn. The horn operating circuit may either be assembled in the proximity sensor 60 or be provided separately

When the module cover 40A is released, the extensions 16A are pushed up into contact with the flanges 51 by the pressure of the coil springs 55, thereby returning the module cover 40A to the normal position shown in FIG. 4. When the extensions 16A move upward, the intensity of the magnetic field of the magnets 61 to the proximity sensors 60 is reduced to a level less than the specified threshold value. As a result, the sensors 60 terminate the horn blowing signal, thereby stopping the blowing of the horn.

As previously discussed, in this embodiment the facing parts 95 are disposed below the extensions 16A such that the extensions 16A and the facing parts 95 approach each other when the module cover 40A is depressed. Alternatively, the facing parts 95 may be disposed above the extensions 16A (such that the airbag system 1A is hung from the facing parts 95) so that the facing parts 95 and the extensions 16A come apart from each other when the module cover 40A is depressed; in this case, when the module cover 40A is depressed to some extent, the output signal from the sensor 60 may be stopped, thereby signaling the horn to sound.

According to the aforementioned embodiment, the distance between the proximity sensor 60 and the magnet 61 is uniquely defined by the length of the guide shaft 50. Accordingly, even if the accuracy of the lateral position of the sensors 60 and the magnets 61 is not high, the horn is still configured to blow reliably when the module cover 40A is depressed by more than the specified distance. As a result, the accuracy required to position of the sensors 60 on the extensions 16A and the magnets 61 on the facing parts 95 is reduced, thereby improving the efficiency of the assembling the airbag system.

As the sensors 60 are of a noncontact type, the sensors 60 have high durability. Moreover, even if water enters between the sensors 60 and the associated magnets 61, the horn switch operation is unaffected. Moreover, although this embodiment uses, as a horn switch, magnetosensitive proximity sensors 60 (possibly having Hall ICs) and magnets 61, this is not required. Rather, e.g., the sensors 60 and magnets 61 of this embodiment may be replaced by the light-emitting elements 73 and corresponding light-receiving elements 74 of the embodiment shown in FIG. 3.

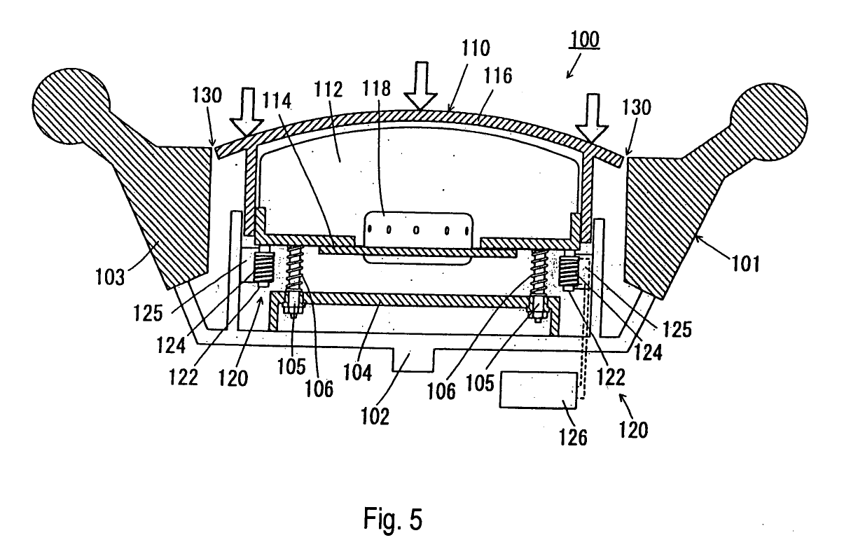

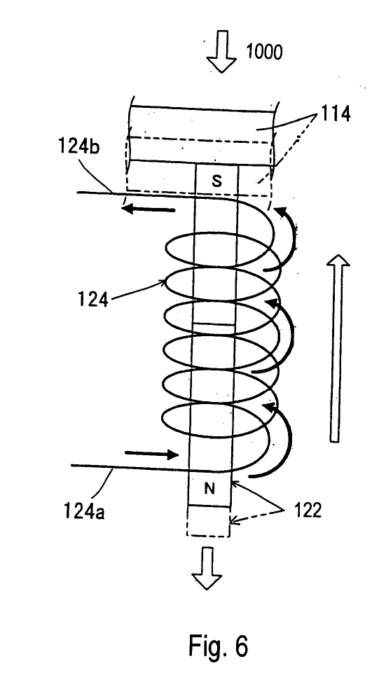

Another embodiment of the present invention will hereafter be described with respect to FIGS. 5 and 6, which show a steering device 100 and an associated horn switch gear 120. As shown in FIG. 5, the steering device 100 includes a ring-shaped steering wheel 101 for an occupant to use for steering a vehicle. An airbag system 110 (or “airbag module”) is disposed inside the outline of the steering wheel 101. A horn switch gear 120 is provided as part of the airbag system 110. The steering wheel 101 may be constructed, e.g., such that a ring-shaped metal core 102 is coated with, e.g., urethane resin 103.

The airbag system 110 according to the embodiment includes: (a) an airbag 112 that inflates toward an occupant protection region in a collision; (b) a metal retainer 114 that accommodates the vehicle airbag 112 folded in a desired form in advance; (c) a module cover 116 (or “module pad”) that covers the side of the airbag 112 adjacent to the occupant and that may be formed of, e.g., resin; and (d) an inflator 118 that can supply inflation gas to the airbag 112.

The airbag 112 is a member that operates in such a way that, when the inflator 118 is activated in a collision to supply inflation gas to the airbag 112, it deploys in an occupant protection region while cleaving the module cover 116 along a tear line (not shown).

The module cover 116 is a member that controls the activation/deactivation of a horn switch 126 (described later) between an “ON state” (in which the horn is sounded by depressing the module cover 116) and an “OFF state” (in which the sounding of the horn is terminated by releasing the module cover 116).

The airbag system 110 of the embodiment is prepared as a preassembled body in which the module cover 116 is preassembled to the retainer 114, before the airbag system 110 is assembled to the steering wheel 101. The airbag system 110 is fixed via guide bolts 105 and coil springs 106. The guide bolts 105, which are disposed between the retainer 114 of the airbag system 110 and a bracket 104 fixed to the metal core 102, connect the retainer 114 to the bracket 104. Each coil spring 106, which is disposed around the guide bolt 105, has the function of applying elastic biasing force in the direction in which the retainer 114 and the bracket 104 separate from each other. In other words, the coil springs 106 serve to bias elastically the module cover 116 of the airbag system 110 toward an initial position (shown in FIG. 5), which is closer to an occupant (i.e., the driver) of the vehicle.

Each of the horn switch gears 120, which include a magnet 122 that is positioned in a corresponding magnetic coil 124; are connected to a horn switch 126. Each of the magnets 122 is fixed to the lower surface of the retainer 114, which moves when the module cover 116 is depressed. The magnets 122 are constructed as longitudinal permanent magnets that extend downward from the lower surface of the retainer 114. The magnetic coils 124 are fixed, via an insulator 125, to the metal core 102, which remains fixed in position when the module cover 116 is depressed. The coils 124 have a coil structure in which a lead wire is wound in a spiral or ring shape.

The horn switch 126, whose position is schematically shown, is electrically connected to the magnetic coils 124 and serves as a switch to sound a horn by passing a predetermined current in a specified direction of one or more of the magnetic coils 124. In other words, according to this embodiment, the current flowing in the magnetic coil 124 serves as direct power supply to activate the horn switch 126.

The operation of this horn switch gear 120 will be described with reference to FIGS. 5 and 6. FIG. 6 schematically shows the operation of a magnet 122 and its associated magnetic coil 124 that construct an exemplary horn switch gear 120 of this embodiment.

When the module cover 116 of the airbag system 110 is depressed from the initial position to an operating position by the occupant, the magnets 122 fixed to the moving-side retainer 114 are moved in the direction of arrow 1000 in FIG. 6, while remaining in their associated magnetic coil 124. At that time, when the retainer 114 moves from the initial position to the operating position, the magnets 122 move with the retainer 114 from the position indicated by the solid line to the position indicated by the dashed line in FIG. 6 (i.e., the retainer 114 and the magnets 122 have the same moving direction and stroke). As a result, the magnets 122 are moving members that can move relative to the associated magnetic coils 124, which are fixed to the metal core 102 of the steering wheel 101. The movement of the magnets 122 causes the associated magnetic coils 124 to generate an induced electromotive force (“EMF”) that passes an induced current through the magnetic coils 124. The induced EMF is generated in the magnetic coil 124 in the direction in which the magnetic field (due to the induced current) prevents a change in the original magnetic field. The phenomenon is based on the principle of so-called “electromagnetic induction.”

This embodiment is constructed such that when the airbag system 110 is depressed (i.e., downward in FIG. 5) against the elastic biasing force of the coil springs 106 by the depression of the module cover 116, the magnets 122 move away from the occupant (i.e., downward in FIG. 6). As a result of the downward movement of the magnets 112, whose lower side may be an N-pole and whose upper side may be S-pole (as shown in FIG. 6), a specified induced current flows from a first end 124a to a second end 124b of the magnetic coil 124.

As the specified current flows in this direction, the horn switch 126, which is electrically connected to the magnetic coils 124, senses the induced current and generates an “ON-state” to blow the horn. On the other hand, when the depression of the module cover 116 is cancelled, the magnets 122 move toward the occupant (i.e., upward in FIG. 6). The upward movement of the magnets 122 in the magnetic coils 124 generates an induced current that flows in the opposite direction, i.e., from the second end 124b to the first end 124a of the magnetic coil 124. As a result, the horn switch 126 senses no specified induced current and, therefore, terminates the “ON-state” (i.e., generates an “OFF-state”), thereby terminating the sounding of the horn.

In this embodiment, any or all of the following can be set so that the magnetic coils 124 can pass a current higher than a specified induced current at the depression of the module cover 116: (a) the magnetic force (magnetic flux density) of the magnet 122; (b) the diameter of the magnetic coils 124; (c) the number of windings of the magnetic coils 124; (d) the pressure required for the occupant to depress the module cover 116 to the operating position (i.e., the elastic biasing force of the coil springs 106 to elastically bias the module cover 116 to the initial position); and (e) the operation stroke of the module cover 116. As a result, by adjusting the magnetic force (magnetic flux density) of the magnet 122 (and/or the diameter of the coils 124 and/or the number of windings of the magnetic coil 124, etc), the magnetic coils 124 can pass a current higher than a specific induced current, while reducing the pressure and operation stroke required to depress the module cover 116. Accordingly, the operability of the horn switch gear 120 can be increased by reducing the pressure and operation stroke required to depress the module cover 116.

In addition to the foregoing, a gap (or clearance) 130 formed between the steering wheel 101 and the outer periphery of the module cover 116 can be minimized by reducing the operation stroke of the module cover 116. As a result, the overall appearance of the steering device 100 may be enhanced.

In this steering device 100 embodiment, the horn switch gear 120 was described as being constructed from multiple sets of magnets 122 and magnetic coils 124 along with multiple coil springs 106 that are disposed around the lower outer periphery of the retainer 114. However, the mounting position and the number of the magnets 122, the magnetic coils 124, and the coil springs 106 is not limited. Rather, the mounting positions of the magnets 122, the magnetic coils 124, and the coil springs 106 only have to be within the region partitioned by the steering wheel 101 and the module cover 116 and can be varied depending on the specifications of the steering device. Moreover, with a structure in which the magnet 122 and the magnetic coil 124 can move relative to each other (as the module cover 116 is depressed), the magnet 122 and the magnetic coil 124 can be disposed on the various components disposed in the region partitioned by the steering wheel 101 and the module cover 116.

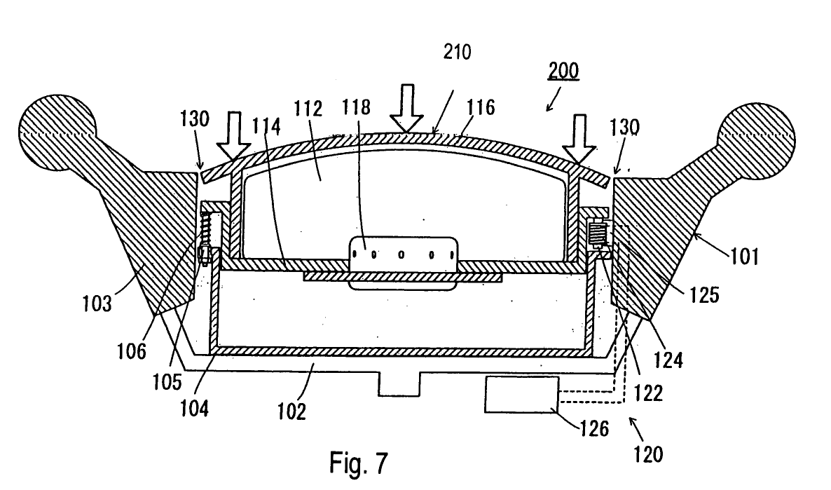

The invention is not limited to the foregoing embodiment of FIGS. 5 and 6. Rather, various applications and modifications can be made, some of which are shown in embodiments hereafter discussed with respect to FIGS. 7-9.

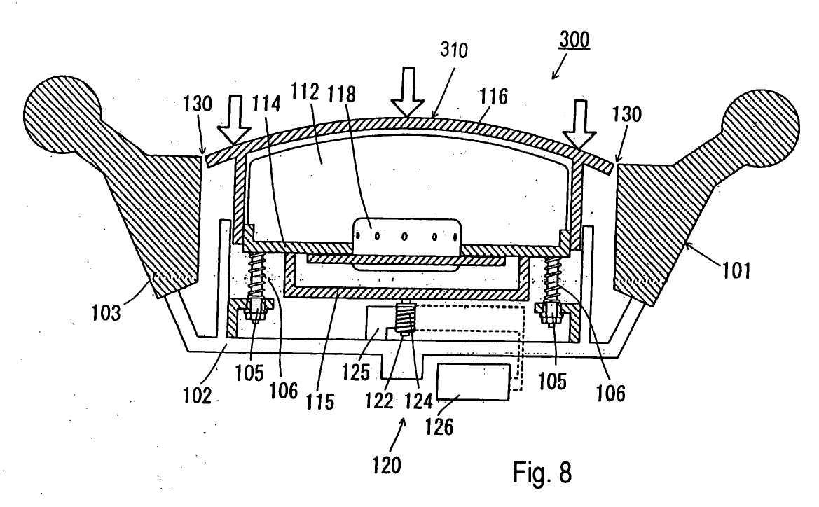

FIGS. 7 and 8 depict alternate embodiments of the mounting positions of the magnet 122, the magnetic coil 124, and the coil spring 106. In FIGS. 7 and 8, the same components as those of FIG. 5 are given the same reference numerals and their detailed description will be omitted.

In a steering device 200 (which includes an airbag system 210) shown in FIG. 7, the horn switch gear 120 is constructed such that the magnet 122 fixed to the retainer 114, the magnetic coil 124 fixed to the steering wheel 101, and the coil spring 106 interposed between the retainer 114 and the bracket 104 are disposed on the side of the retainer 114. With such a mounting structure, the horn operability and the overall appearance of the steering devices 200 can be improved similar to that of the steering device 100 shown in FIGS. 5 and 6.

In a steering device 300 (which includes an airbag system 310) shown in FIG. 8, the magnet 122 fixed to a bracket 115 of the retainer 114 and the magnetic coil 124 fixed to the metal core 102 are disposed in the lower center of the retainer 114, whereas the coil springs 106 are disposed at the lower outer periphery of the retainer 114. With such a mounting structure, the horn operability and the overall appearance of the steering devices 300 can be improved similar to that of the steering device 100 shown in FIGS. 5 and 6.

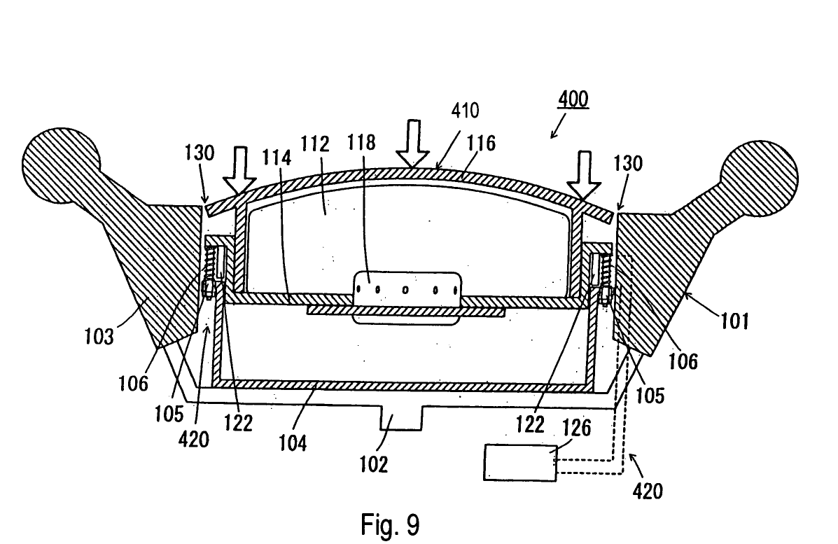

In each of the aforementioned steering devices 100, 200, 300, the magnetic coils 124 and the coil springs 106 are separated from each other. However, the invention may be constructed such that the magnetic coil 124 also serves as the coil spring 106; such an embodiment will be described with reference to FIG. 9. In FIG. 9, the same components as those of FIG. 5 are given the same reference numerals and their detailed description will be omitted.

A horn switch gear 420 of a steering device 400 shown in FIG. 9 is constructed such that the coil springs 106 disposed on the sides of the retainer 114 serve the function of the magnetic coils 124 in addition to the original function of elastically biasing the airbag system 410 to the initial position. Specifically, as the magnets 122 fixed to the retainer 114 and the coil springs 106 interposed between the retainer 114 and the bracket 104 move relative to each other when the module cover 116 is depressed, a specified induced current is generated in the coil springs 106. The horn switch 126 senses the induced current and generates an “ON-state” that causes the horn to sound. As a result of the structure of this steering device 400, the horn operability and the appearance can be improved, as with the previously discussed steering devices 100, 200, 300. In addition, however, the number of components can be reduced by using the coil springs 106 to serve the function of magnetic coils 124, thereby facilitating the construction of the horn switch gear 420.

In the foregoing steering devices 100, 200, 300, 400, the magnets 122 are disposed on a retainer 114 that moves as a result of a depression (by occupant force) of the module cover 116, whereas the magnetic coils 124 are disposed on the stationary metal core 102. Alternatively, the invention may use a structure in which the magnetic coils 124 is disposed on the movable retainer 114, whereas the magnets 122 are disposed on the stationary metal core 102. In other words, these steering device embodiments 100, 200, 300, 400 only need a structure in which the magnets 122 and the magnetic coils 124 move relative to each other.

Although in the aforementioned embodiments the module cover 116 (of the airbag systems 110, 210, 310, 410) and the retainer 114 move integrally when the module cover 116 is depressed, other embodiments may contemplate a scenario in which the module cover 116 moves in isolation from the retainer 114 at depression, i.e., the module cover 116 may be of a so-called floating cover (floating pad) type in which the module cover 116 “floats” on the retainer 140. With this structure, for example, the magnets 122 may be disposed to the moving-side module cover 116, whereas the magnetic coils 124 may be disposed to the stationary metal core 102.

Although in the aforementioned embodiments the horn is activated by the depression of the module cover 116 that covers the occupant side of the airbag 112, the invention can be applied to an airbag system and a steering device that include a horn operating member such as a horn operating cover used only to activate the horn and a horn operating button (switch). With such a structure, for example, the magnet 122 may be disposed on the horn operating member (i.e., on the moving side), whereas the magnetic coil 124 may be disposed on the stationary metal core 102 (i.e., on the fixed side).

In the horn switch gear of the above embodiments, the induced current generated by the relative movement of the magnets 122 and the magnetic coils 124 serves as direct power supply for the horn switch 126 to activate the horn. Alternatively, the induced current may be used as power supply for a controller that is configured to control the operation of the horn switch 126 etc.

Although in the aforementioned embodiments the structure of the steering device of an automobile has been described, the invention is applicable to the structure of the steering device of vehicles other than automobiles, for example, vessels and trains.

The aforementioned embodiments are merely examples of the invention and other structures other than those illustrated can be made. For example, the invention may use other magnetosensitive horn switches such as a lead switch.

In other embodiments, the invention may be constructed such that the distance between the overhang 45 and the extension 16 or the distance between the extension 16A and the facing part 95 is measured with light or ultrasonic waves. As a result, when the measured distance exceeds a specified value, the horn may be sounded.

Although a proximity sensor having a Hall IC may be used as the noncontact sensor, the invention is not limited to such a proximity sensor. Rather, other proximity sensors may be used and, therefore, the type of proximity sensor is not limiting on the scope of the invention.

The priority applications, Japanese Application Nos. 2004-229729, 2004-358575, 2005-011776, and 2005-146871, which were filed on Aug. 5, 2004, Dec. 10, 2004, Jan. 19, 2005, and May 19, 2005, respectively, and which are incorporated herein by reference in their entireties.

Given the disclosure of the present invention, one versed in the art would appreciate that there may be other embodiments and modifications within the scope and spirit of the invention. Accordingly, all modifications attainable by one versed in the art from the present disclosure that are within the scope and spirit of the present invention are to be included as further embodiments of the present invention. The scope of the present invention is to be defined as set forth in the following claims.

What is claimed is:

1. A horn switch gear comprising:
a backward moving body that is configured to move backward in a depression direction when depressed by an occupant;
an unmoving body that faces the backward moving body;
a biasing member that is interposed between the backward moving body and the unmoving body and that is configured to bias the backward moving body in a restoring direction that is opposite the depression direction; and
a signal generator that is configured to generate a horn blowing signal in response to the movement of the backward moving body in the depression direction,
wherein the signal generator includes a noncontact sensor.

2. The horn switch gear according to claim 1, wherein the noncontact sensor includes a Hall IC.

3. An airbag system comprising:
a horn switch gear comprising:
a backward moving body that is configured to move backward in a depression direction when depressed by an occupant;
an unmoving body that faces the backward moving body;
a biasing member that is interposed between the backward moving body and the unmoving body and that is configured to bias the backward moving body in a restoring direction that is opposite the depression direction; and
a signal generator that is configured to generate a horn blowing signal in response to the movement of the backward moving body in the depression directions,
wherein the signal generator includes a noncontact sensor.

4. The airbag system according to claim 3, wherein the noncontact sensor includes a Hall IC.

5. A steering wheel comprising:
a horn switch gear comprising:
a backward moving body that is configured to move backward in a depression direction when depressed by an occupant;
an unmoving body that faces the backward moving body;
a biasing member that is interposed between the backward moving body and the unmoving body and that is configured to bias the backward moving body in a restoring direction that is opposite the depression direction; and
a signal generator that is configured to generate a horn blowing signal in response to the movement of the backward moving body in the depression and restoring directions,
wherein the signal generator includes a noncontact sensor.

6. The steering wheel according to claim 5, wherein the noncontact sensor includes a Hall IC.

7. The steering wheel according to claim 5, further comprising:
an airbag system that comprises the horn switch gear.

8. A horn switch gear provided on a vehicle steering wheel, the horn switch gear comprising:
a first component;
a second component that is biased a specified distance away from the first component by a biasing element that generates a biasing force;
a magnet; and
a magnetic coil,
wherein the second component is configured to be moved by being depressed, against the biasing force, to an operating position at which a horn is configured to sound,
wherein the movement of the second component toward the operating position is in a direction toward the first component,
wherein the sounding of the horn is configured to be terminated by releasing the depression on the second member,
wherein the magnet moves relative to the magnetic coil when the second component moves toward the operating position, and
wherein the movement of the magnet relative to the magnetic coil induces current in the magnetic coil, thereby sounding the horn.

9. The horn switch gear according to claim 8, wherein one of the first and second components includes the magnet, and wherein the other of the first and second components includes the magnetic coil.

10. The horn switch gear according to claim 8, wherein the magnetic coil is a coil spring interposed between the first and second components.

11. The horn switch gear according to claim 10, wherein the coil spring is configured to elastically bias the second component the specified distance away from the first component.

12. An airbag system comprising:
a vehicle steering wheel;
a horn switch gear provided on the vehicle steering wheel, the horn switch gear comprising:
a first component;
a second component that is biased a specified distance away from the first component by a biasing member that generates a biasing force;
a magnet; and
a magnetic coil,
wherein the second component is configured to be moved by being depressed, against the biasing force, to an operating position at which a horn is configured to sound,
wherein the movement of the second component toward the operating position is in a direction toward the first component,
wherein the sounding of the horn is configured to be terminated by releasing the depression on the second member,
wherein the magnet moves relative to the magnetic coil when the second component moves toward the operating position, and
wherein the movement of the magnet relative to the magnetic coil induces current in the magnetic coil, thereby sounding the horn;
an airbag that is configured to be deployed toward an occupant in the event of a collision;
a retainer that accommodates the airbag in a folded state;
an inflator that is configured to supply inflation gas to the airbag; and
an airbag cover that covers a part of the airbag that is adjacent to the occupant.

13. The airbag system according to claim 12, wherein one of the first and second components includes the magnet, and wherein the other of the first and second components includes the magnetic coil.

14. The airbag system according to claim 12, wherein the magnetic coil is a coil spring interposed between the first and second components.

15. The airbags system according to claim 14, wherein the coil spring is configured to elastically bias the second component the specified distance away from the first component.

16. The airbag system according to claim 12, wherein the second component is the airbag cover.

17. A steering device comprising:
a vehicle steering wheel;
a horn switch gear provided on the vehicle steering wheel, the horn switch gear comprising:
a first component;
a second component that is biased a specified distance away from the first component by a biasing element that generates a biasing force;
a magnet; and
a magnetic coil,
wherein the second component is configured to be moved by being depressed, against the biasing force, to an operating position at which a horn is configured to sound,
wherein the movement of the second component toward the operating position is in a direction toward the first component,
wherein the sounding of the horn is configured to be terminated by releasing the depression on the second member,
wherein the magnet moves relative to the magnetic coil when the second component moves toward the operating position, and
wherein the movement of the magnet relative to the magnetic coil induces current in the magnetic coil, thereby sounding the horn;
an airbag that is configured to be deployed toward an occupant in the event of a collision;
a retainer that accommodates the airbag in a folded state;
an inflator that is configured to supply inflation gas to the airbag; and
an airbag cover that covers a part of the airbag that is adjacent to the occupant.

18. The steering device according to claim 17, wherein one of the first and second components includes the magnet, and wherein the other of the first and second components includes the magnetic coil.

19. The steering device according to claim 17, wherein the magnetic coil is a coil spring interposed between the first and second components.

20. The steering device according to claim 19, wherein the coil spring is configured to elastically bias the second component the specified distance away from the first component.
